(19) United States
(12) Patent Application Publication
(10) Pub. No.: US 2009/0021514 A1
(43) Pub. Date: Jan. 22, 2009

(54) HANDLING RASTER IMAGE 3D OBJECTS

(76) Inventor: Mark Klusza, Swampscott, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/125,650

(22) Filed: May 22, 2008

Related U.S. Application Data
(60) Provisional application No. 60/939,419, filed on May 22, 2007.

(51) Int. Cl. G06T 15/00; G06F 17/30

(52) U.S. Cl. 345/419; 707/1; 707/E17.001

(57) ABSTRACT

A raster image 3D platform provides methods and systems to facilitate image capture, position detection, and association of the image and position to create a raster image 3D object for modeling and simulation. The 3D object model, when combined with rendered 3D model, can be used in 3D simulation for design and planning purposes. Metadata can be combined with the raster image object to record important aspects of the object such as position, direction, environment, and the like that can be applied to a simulation of the object.

### CROSS-REFERENCE TO RELATED APPLICATIONS

This application claims the benefit of U.S. provisional application Ser. No. 60/939,419 filed May 22, 2007 which is hereby incorporated by reference in its entirety.

### BACKGROUND

### Field

The invention generally relates to acquisition, management and analysis of image data.

### SUMMARY

A raster image three dimensional (3D) data collection, management, analysis and presentation platform may include facilities for collecting data, including image data. Collecting data may include various hardware and software technologies, such as image sensors, laser technologies, video technologies, pulse reading technologies, magnetometers, radar, flash technology and the like, as well as image registration software and other data collection related software. Collecting data may also include a location facility, such as GPS, but also possibly a gyro-based system or a dead reckoning system such as may be beneficial for indoor location data collection efforts. A raster image data collector may feed a raster image 3D platform to facilitate managing raster image data as objects.

A raster image 3D platform may include a data management facility. A data management facility may include methods and systems for managing data sets, such as to manage sets of raster image data as objects and to manage metadata associated with those objects. Data management may facilitate management of raster image data as 3D objects that can be used interchangeably with (but are distinct in type from) components of 3D models, such as 3D CAD models that are used in a wide range of design environments, including design of power plants. Data management may also facilitate associating raster image data objects with other data sets, such as spatial location data associated with GPS inputs or inputs from other location systems, such as gyro-based systems. Data management may also include data transformation applications, such as transforming raster image data objects into formats suitable for use in various IT systems, such as systems used for design or maintenance of various kinds of facilities.

A raster image 3D platform may include data storage facilities. Data storage facilities may be suitable for storing large amounts of raster image data in order to support data objects described herein, but also for effectively enabling various database functions on such data, such as access, versioning, partitioning, security, conditional access, query formation, transaction tracking, logging, and the like. The platform may also include interfaces to data storage facilities, such as web services interfaces or other services oriented interfaces.

A raster image 3D platform may include data processing methods and systems that extend beyond the data management methods and systems described herein. Data processing may include segmenting data to support display in a range of different display environments and other methods for processing raster image data. Data processing may also include analyzing data sets, such as for assisting with matching raster image data sets to a library of predefined objects, such as objects typically found in a particular environment (e.g., matching a substantially cylindrical image data set to a “pipe” object in a CAD model). Data processing may also include processing techniques for inserting data sets captured with the data collector into parts of a different model, such as a 3D CAD model, or vice versa, to create a model that is a hybrid of rendered model data and real object data captured by the data collector. Data processing may also include higher-level analytics and processing, such as used to support various use scenarios or integration with external systems, as well as methods and systems for associating metadata with raster image object data and managing the use of that metadata.

A raster image 3D platform may include user interface features and process flows for a range of user interfaces, such as interfaces corresponding to various users, including facilities managers, engineers, construction managers, facility owners, database managers/IT professionals, service providers, and others. Each user category can have its own user interface, which may include features associated with the display and manipulation of data objects supported by the platform, such as raster image data objects captured by the data collector or hybrids of raster image data objects with other 3D objects, such as from conventional 3D models. The user interface for each user type may include other features suitable for a particular use scenario for that user. User interface features may include different display facilities, such as voxel-based displays, triangle-based displays, or the like. One embodiment may allow progressive refinement of raster image data, so that a portion, or sub sample of raster image data may be used for rough views, while more refined views are available by populating the interface with more condensed (and larger) sets of image points.

A raster image 3D platform may include other systems with which a data collection and processing system can be integrated or combined, as well as interfaces between the respective systems. Among various possible systems are GPS systems, CAD systems, plant management and maintenance systems, IT systems for various environments, gyro-based location systems, rover systems (or other systems for transporting a data collector), and the like. In an example of integration with other systems, a data collector for above ground data may be combined with ground-penetrating radar for below ground data. Such a combination might be transported on a cart for high-speed data collection, such as on a roadway.

A raster image 3D platform may be beneficially applied in various environments in which a data collection and processing system might be used. The platform may support various use scenarios that take advantage of core elements of the platform in combination with other aspects such as third-party integration, data storage, networking, and the like. Use scenarios that may benefit from the platform may include a core plant environment, major project environments, such as ones that use modeling at the design or maintenance phase. Other use scenarios may include roadway construction and other major construction environments, maintenance of buildings and equipment, and the like. Use scenarios may also include population of conventional 3D models with raster image data objects, maintenance record keeping, tracking of underground or hidden features, documentation of construction for proof of milestone completion, and others.

In an aspect of the invention, a method of storing raster image data as an object may include collecting raster image data of an environment; storing the raster image data in a spatial database; and associating at least a portion of the raster image data with an object identifier.

In another aspect of the invention, a method of associating raster image data with a 3D model may include taking a raster image data object, and associating the raster image data object with a 3D rendering model, so that the 3D rendered model can use the raster image data as an object within the model.

In another aspect of the invention, a method for associating 3D raster image data object with spatial location data in a spatial data storage facility may include storing a raster image data object from an image collected in an environment in a spatial data storage facility, and associating the raster image data object with spatial location data for the environment in which the raster image data object was collected.

In another aspect of the invention, a method for presenting a 3D raster image object in a 3D modeling program simultaneously with presenting a 3D model object may include taking a raster image data object formed from image data collected in an environment; taking a 3D model object generated in a 3D model; and presenting the raster image data object and the 3D model object in a common user interface, wherein a user can manipulate the raster image data object and the 3D model object in the user interface.

In embodiments, the present invention provides methods and systems for collecting raster image data of an environment, storing at least a portion of the raster image data as an object in a spatial database, and associating an object identifier with the object, thereby facilitating management of the portion of the raster image data as a database object.

In embodiments, storing the raster image data in the spatial database may enable a database function. In embodiments, the database function may include at least one of data access, versioning, partitioning, security, conditional access, query formation, transaction tracking, logging, or some other type of function.

In embodiments, the spatial database may be accessible through a web service.

In embodiments, the object may be a hybrid object. In embodiments, the hybrid object may include object model data and associated image data. In embodiments, the object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of data. In embodiments, the raster image data attributes may be associated with the object identifier.

In embodiments, the raster image data may include metadata. In embodiments, the metadata may impact associating the object. In embodiments, the metadata may include volumetric information associated with the raster image data. In embodiments, the raster image data metadata may be associated with the object identifier.

In embodiments, the raster image data may include parameters. In embodiments, the parameters may be associated with individual data points, groups of data points, data segments, the object identifier, or some other type of information. In embodiments, the parameters may be weighted to maintain real world properties associated with an environment. In embodiments, the environment may be the raster image data capture environment.

In embodiments, the raster image data may comprise discrete raster image data points such as one or more sets of associated data points. In embodiments, the one or more sets of associated data points may be associated with the object identifier or may be manipulated as a single raster object.

In embodiments, the raster image data may further be transformed. In embodiments, the transformation may include transforming raster image data into at least one format suitable for use in 3D design.

In embodiments, associating may include presenting the raster image data and the object identifier to a user for confirmation of the association. In embodiments, the association may be conditional based on the user confirmation. In embodiments, associating may include matching raster image data to a library of predefined objects. In embodiments, the library may facilitate virtual construction of 3D items through connection features of the raster image objects.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, the object, or some other parameter. In embodiments, weighting may facilitate spatially aligning data from different collection sources. In embodiments, the raster image data weight may impact an association of the raster image data with spatial location data.

In embodiments, the present invention provides methods and systems for providing an image acquisition facility to acquire raster image data, providing a location facility, wherein the location facility may provide location reference for the raster image data, associating the location data with the raster image data to provide location-referenced raster image data and feeding the location-referenced raster image data to a computer-based platform to facilitate managing raster image data as a location-based object in the platform.

In embodiments, the object may be a hybrid object. In embodiments, the hybrid object may include object model data and associated image data. In embodiments, the object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object.

In embodiments, the raster image data may include metadata. In embodiments, the metadata may impact associating raster image data. In embodiments, the metadata may include volumetric information associated with the raster image data. In embodiments, the raster image data metadata may be associated with the object.

In embodiments, the raster image data may include parameters. In embodiments, the parameters may be associated with individual data points, groups of data points, data segments, the object, or some other type of information. In embodiments, the parameters may be weighted to maintain real world properties associated with an environment. In embodiments, the environment may be the raster image data capture environment.

In embodiments, the raster image data may comprise discrete raster image data points such as one or more sets of associated data points. In embodiments, the one or more sets of associated data points may be associated with the object or may be manipulated as a single raster object.

In embodiments, the location-referenced raster image data may further be transformed. In embodiments, the transformation may include transforming raster image data into at least one format suitable for use in 3D design.

In embodiments, associating may include presenting the location-referenced raster image data and the location data to a user for confirmation of the association. In embodiments, the association may be conditional based on the user confirmation.

In embodiments, associating may include matching raster image data to a library of predefined objects. In embodiments, the library may facilitate virtual construction of 3D items through connection features of the raster image objects.

In embodiments, collecting raster image data may include the raster image acquisition facility acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include the raster image acquisition facility acquiring raster image data using image acquisition software. In embodiments, image acquisition software may include image registration software, data collection software, or some other type of software for image acquisition.

In embodiments, collecting raster image data may include the raster image acquisition facility acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, the location-referenced object, or some other parameter. In embodiments, weighting may facilitate spatially aligning data from different collection sources. In embodiments, the raster image data weight may impact an association of the raster image data with location data.

In embodiments, the location facility may be selected from GPS, a gyro-based system, compass, a dead reckoning system, or some other type of location facility. In embodiments, the location facility may be adapted to facilitate indoor location data collection.

In embodiments, the present invention provides methods and systems for collecting raster image object data for an environment, collecting spatial location data for the environment, associating the raster image data with the spatial location data, and storing the associated raster image data and the spatial location data in a spatial data storage facility.

In embodiments, associating the raster image data with the spatial location data may provide a raster image data object. In embodiments, the raster image data object may be a three-dimensional object.

In embodiments, the spatial location data may be geo-referenced.

In embodiments, the object may be a hybrid object. In embodiments, the hybrid object may include object model data and associated image data. In embodiments, the object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object.

In embodiments, the raster image data may include metadata. In embodiments, the metadata may impact associating raster image data. In embodiments, the metadata may include volumetric information associated with the raster image data. In embodiments, the raster image data metadata may be associated with the object.

In embodiments, the raster image data may include parameters. In embodiments, the parameters may be associated with individual data points, groups of data points, data segments, the object, or some other type of information. In embodiments, the parameters may be weighted to maintain real world properties associated with an environment. In embodiments, the environment may be the raster image data capture environment.

In embodiments, the raster image data may comprise discrete raster image data points such as one or more sets of associated data points. In embodiments, the one or more sets of associated data points may be associated with the object or may be manipulated as a single raster object.

In embodiments, the raster image data may further be transformed. In embodiments, the transformation may include transforming raster image data into at least one format suitable for use in 3D design.

In embodiments, associating may include presenting the raster image data and the object to a user for confirmation of the association. In embodiments, the association may be conditional based on the user confirmation.

In embodiments, associating may include matching raster image data to a library of predefined objects. In embodiments, the library may facilitate virtual construction of 3D items through connection features of the raster image objects.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, a raster image data object, or some other parameter. In embodiments, weighting may facilitate spatially aligning data from different collection sources. In embodiments, the raster image data weight may impact an association of the raster image data with spatial location data.

In embodiments, the spatial location data may be collected by a spatial location facility such as GPS, a gyro-based system, compass, a dead reckoning system, or some other type of location facility. In embodiments, the spatial location facility may be adapted to facilitate indoor location data collection.

In embodiments, the present invention provides methods and systems for presenting a 3D raster image object in a 3D modeling program simultaneously with presenting a 3D model object that may comprise taking a raster image data object formed from image data collected in an environment, taking a 3D model object generated in a 3D model and presenting the raster image data object and the 3D model object in a common user interface, wherein a user may manipulate the raster image data object and the 3D model object in the user interface.

In embodiments, the present invention may further provide manipulation features in the user interface. In embodiments, the manipulation features may include at least one of controlling data collection, creating hybrid 3D objects, changing object formats, connecting objects, rotating objects, or some other type of manipulation feature.

In embodiments, connecting objects may be based on real world connections represented in the raster image data object. In embodiments, the real world connections may include threads, snaps, press fits, welds, sockets, locking features, joining, surface mating, or some other types of connections.

In embodiments, connectivity of objects may be based on a compatibility of connection points of the objects. In embodiments, the connections points of the objects may be determined based on an association of the raster image data object and the 3D model object.

In embodiments, rotating objects may be based on rotation rules. In embodiments, rotation rules may be associated with one or more connection axes, rotation axes, or some other type of axes.

In embodiments, a user command to manipulate a raster object may be represented by changing a screen presentation of the raster object without re-rasterizing the changed object.

In embodiments, the raster image data object may be a hybrid object. In embodiments, the hybrid object may include object model data and associated image data. In embodiments, the raster image data object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source.

In embodiments, the raster image data may include metadata. In embodiments, the metadata may impact associating raster image data. In embodiments, the metadata may include volumetric information associated with the raster image data.

In embodiments, the raster image data may include parameters. In embodiments, the parameters may be associated with individual data points, groups of data points, data segments, the object identifier, or some other type of information. In embodiments, the parameters may be weighted to maintain real world properties associated with an environment. In embodiments, the environment may be the raster image data capture environment.

In embodiments, the raster image data may comprise discrete raster image data points such as one or more sets of associated data points. In embodiments, the one or more sets of associated data points may be manipulated as a single raster object.

In embodiments, the raster image data may further be transformed. In embodiments, the transformation may include transforming raster image data into at least one format suitable for use in 3D design.

In embodiments, presenting may include presenting the raster image data and the 3D object to a user for confirmation of an association of the raster image data with the 3D object. In embodiments, the association may be conditional based on the user confirmation.

In embodiments, the raster image data may further be weighed. In embodiments, the weighting may include weighting one or more of individual raster image data points, one or more sets of raster image data points, segments of raster image data points, a raster image data object, or some other parameter. In embodiments, weighting may facilitate spatially aligning data from different collection sources. In embodiments, the raster image data weight may impact an association of the raster image data with spatial location data.

In embodiments, the present invention provides methods and systems for collecting raster image data of an environment, storing at least a portion of the raster image data as an object in a spatial database and associating the object with a 3D model, so that the 3D model may use the object within the 3D model.

In embodiments, the 3D model may be a 3D rendering model.

In embodiments, associating may include segmenting the object into at least two segments and associating at least one of the segments with a 3D model such as 3D rendering model.

In embodiments, the raster image data object may be a hybrid object. In embodiments, the hybrid object may include object model data and associated image data. In embodiments, the raster image data object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object.

In embodiments, the raster image data may include metadata. In embodiments, the metadata may impact associating the object. In embodiments, the metadata may include volumetric information associated with the raster image data. In embodiments, the raster image data metadata may be associated with the object.

In embodiments, the raster image data may include parameters. In embodiments, the parameters may be associated with individual data points, groups of data points, data segments, the object, or some other type of information. In embodiments, the parameters may be weighted to maintain real world properties associated with an environment. In embodiments, the environment may be the raster image data capture environment.

In embodiments, the raster image data may comprise discrete raster image data points such as one or more sets of associated data points. In embodiments, the one or more sets of associated data points may be associated with the object or may be manipulated as a single raster object.

In embodiments, the raster image data may further be transformed. In embodiments, the transformation may include transforming raster image data into at least one format suitable for use in 3D design.

In embodiments, associating may include presenting the object and the 3D model to a user for confirmation of the association. In embodiments, the association may be conditional based on the user confirmation.

In embodiments, associating may include matching the object to a library of predefined 3D models. In embodiments, the library may facilitate virtual construction of 3D items through connection features of the objects.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, the object, or some other parameter. In embodiments, weighting may facilitate spatially aligning data from different collection sources. In embodiments, the raster image data weight may impact an association of at least a portion of the raster image data with spatial location data.

In embodiments, the present invention provides methods and systems for providing an image acquisition facility to acquire raster image data, providing a location facility, wherein the location facility may provide a location reference for the raster image data, associating the location data with the raster image data to provide location-referenced raster image data, storing at least a portion of the geo-referenced raster image data as an object in a spatial database, and associating an object identifier with the object, thereby facilitating management of the portion of the location-referenced raster image data as a database object.

In embodiments, the object may be a hybrid object. In embodiments, the hybrid object may include object model data and associated image data. In embodiments, the object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object identifier.

In embodiments, the raster image data may include metadata. In embodiments, the metadata may impact associating the object identifier. In embodiments, the metadata may include volumetric information associated with the raster image data. In embodiments, the raster image data metadata may be associated with the object identifier.

In embodiments, the raster image data may include parameters. In embodiments, the parameters may be associated with individual data points, groups of data points, data segments, the object identifier, or some other type of information. In embodiments, the parameters may be weighted to maintain real world properties associated with an environment. In embodiments, the environment may be a capture environment.

In embodiments, the raster image data may comprise discrete raster image data points such as one or more sets of associated data points. In embodiments, the one or more sets of associated data points may be associated with the object identifier or may be manipulated as a single raster object.

In embodiments, the raster image data may further be transformed. In embodiments, the transformation may include transforming raster image data into at least one format suitable for use in 3D design.

In embodiments, associating the object identifier may include presenting the raster image data and the object identifier to a user for confirmation of the association. In embodiments, the association may be conditional based on the user confirmation.

In embodiments, associating the object identifier may include matching the location-referenced raster image data to a library of predefined objects. In embodiments, the library may facilitate virtual construction of 3D items through connection features of the raster image objects.

In embodiments, the raster image data may further be weighed. In embodiments, the weighting may include weighting one or more of individual raster image data points, one or more sets of raster image data points, segments of raster image data points, the object, or some other parameter. In embodiments, weighting may facilitate spatially aligning data from different collection sources. In embodiments, the raster image data weight may impact an association of at least a portion of the raster image data with location data.

In embodiments, the location facility may be selected from GPS, a gyro-based system, compass, a dead reckoning system, or some other type of location facility.

In embodiments, the location facility may be adapted to facilitate indoor location data collection.

In embodiments, the present invention provides methods and systems for collecting raster image data of an environment, collecting spatial location data for the environment, associating the raster image data with the spatial location data, storing at least a portion of the associated raster image and location data as an object in a spatial data storage facility and associating an object identifier with the object, thereby facilitating management of the portion of the associated raster image and location data as a database object.

In embodiments, the object may be a hybrid object. In embodiments, the hybrid object may include object model data and associated image data. In embodiments, the object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object identifier.

In embodiments, the raster image data may include metadata. In embodiments, the metadata may impact associating the object identifier. In embodiments, the metadata may include volumetric information associated with the raster image data. In embodiments, the raster image data metadata may be associated with the object identifier.

In embodiments, the raster image data may include parameters. In embodiments, the parameters may be associated with individual data points, groups of data points, data segments, the object identifier, or some other type of information. In embodiments, the parameters may be weighted to maintain real world properties associated with an environment. In embodiments, the environment may be a capture environment.

In embodiments, the raster image data may comprise discrete raster image data points such as one or more sets of associated data points. In embodiments, the one or more sets of associated data points may be associated with the object identifier or may be manipulated as a single raster object.

In embodiments, the raster image data may further be transformed. In embodiments, the transformation may include transforming raster image data into at least one format suitable for use in 3D design.

In embodiments, associating the object identifier may include presenting the raster image data and the object identifier to a user for confirmation of the association. In embodiments, the association may be conditional based on the user confirmation.

In embodiments, associating the object identifier may include matching the object to a library of predefined objects. In embodiments, the library may facilitate virtual construction of 3D items through connection features of the pre-defined objects.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, the object, or some other parameter. In embodiments, weighting may facilitate spatially aligning data from different collection sources. In embodiments, the raster image data weight may impact an association of at least a portion of the raster image data with location data.

In embodiments, the location facility may be selected from GPS, a gyro-based system, compass, a dead reckoning system, or some other type of location facility.

In embodiments, the location facility may be adapted to facilitate indoor location data collection.

In embodiments, the present invention provides methods and systems for collecting raster image data of an environment, storing at least a portion of the raster image data as an object in a spatial database, associating an object identifier with the object, taking a 3D model object generated in a 3D model and presenting the object identifier and the 3D model object in a common user interface, wherein a user may manipulate the object associated with the object identifier and the 3D model object in the user interface.

In embodiments, the object identifier may identify a hybrid object. In embodiments, the hybrid object may include object model data and associated image data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object identifier.

In embodiments, the raster image data may include metadata. In embodiments, the metadata may impact associating the object identifier. In embodiments, the metadata may include volumetric information associated with the raster image data. In embodiments, the raster image data metadata may be associated with the object identifier.

In embodiments, the raster image data may include parameters. In embodiments, the parameters may be associated with individual data points, groups of data points, data segments, the object identifier, or some other type of information. In embodiments, the parameters may be weighted to maintain real world properties associated with an environment. In embodiments, the environment may be a capture environment.

In embodiments, the raster image data may comprise discrete raster image data points such as one or more sets of associated data points. In embodiments, the one or more sets of associated data points may be associated with the object identifier or may be manipulated as a single raster object.

In embodiments, the raster image data may further be transformed. In embodiments, the transformation may include transforming raster image data into at least one format suitable for use in 3D design.

In embodiments, associating the object identifier may include presenting the raster image data and the object identifier to a user for confirmation of the association of the 3D model object and the object associated with the object identifier. In embodiments, the association may be conditional based on the user confirmation.

In embodiments, associating the object identifier may include matching the object to a library of predefined objects. In embodiments, the library may facilitate virtual construction of 3D items through connection features of the raster image object.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, a raster image data object, or some other parameter. In embodiments, weighting may facilitate spatially aligning data from different collection sources. In embodiments, the raster image data weight may impact an association of the raster image data with spatial location data.

In embodiments, the present invention provides methods and systems for collecting raster image data for an environment, collecting spatial location data for the environment and associating the raster image data and the spatial location data with a 3D rendering model, so that the 3D rendering model may use the raster image data and the spatial location data together as an object within the 3D rendering model. In embodiments, this method may further include storing the associated raster image and spatial location data as an object in a spatial data storage facility.

In embodiments, associating may include associating the raster image data with the spatial location data providing a raster image object and associating the raster image object with the 3D rendering model.

In embodiments, the 3D model may include a plurality of data types such as raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source.

In embodiments, the raster image data may include metadata. In embodiments, the metadata may impact associating the raster image data. In embodiments, the metadata may include volumetric information associated with the raster image data.

In embodiments, the raster image data may include parameters. In embodiments, the parameters may be associated with individual data points, groups of data points, data segments, the spatial location data, or some other type of information. In embodiments, the parameters may be weighted to maintain real world properties associated with an environment. In embodiments, the environment may be a capture environment.

In embodiments, the raster image data may comprise discrete raster image data points such as one or more sets of associated data points. In embodiments, the one or more sets of associated data points may be associated with the object identifier or may be manipulated as a single raster object.

In embodiments, the raster image data may further be transformed. In embodiments, the transformation may include transforming raster image data into at least one format suitable for use in 3D design.

In embodiments, associating may include presenting the raster image data and the 3D rendering model to a user for confirmation of the association of the raster image data, the spatial location data and the 3D rendering model. In embodiments, the association may be conditional based on the user confirmation.

In embodiments, associating the object identifier may include matching raster image data to a library of predefined objects. In embodiments, the library may facilitate virtual construction of 3D items through connection features of the raster image objects.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, a raster image data object, or some other parameter. In embodiments, weighting may facilitate spatially aligning data from different collection sources. In embodiments, the raster image data weight may impact an association of the raster image data with spatial location data.

In embodiments, collecting the spatial location data may be performed by a spatial location facility that is selected from GPS, a gyro-based system, compass, a dead reckoning system, or some other type of facility. In embodiments, the spatial location facility may be adapted to facilitate indoor location data collection.

In embodiments, the present invention provides methods and systems for collecting raster image object data for an environment, collecting spatial location data for the environment, associating the raster image data with the spatial location data providing a raster image data object, taking a 3D model object generated in a 3D model, and presenting the raster image data object and the 3D model object in a common user interface, wherein a user may manipulate the raster image data object and the 3D model object in the user interface. In embodiments, the method may further include storing the associated raster image and spatial location data as an object in a spatial data storage facility.

In embodiments, the raster image data object may be a hybrid object. In embodiments, the hybrid object may include object model data and associated image data. In embodiments, the object may include a plurality of data types. In embodiments, the data types may include raster image data, location data, rendered CAD library model data, or some other type of data.

In embodiments, the raster image data may include attributes. In embodiments, the attributes may be selected from data collection source, raster image subject, data collection environment, raster image data organization, or some other type of attribute source. In embodiments, the raster image data attributes may be associated with the object.

In embodiments, the raster image data may include metadata. In embodiments, the metadata may impact associating raster image data. In embodiments, the metadata may include volumetric information associated with the raster image data. In embodiments, the raster image data metadata may be associated with the object.

In embodiments, the raster image data may include parameters. In embodiments, the parameters may be associated with individual data points, groups of data points, data segments, the object, or some other type of information. In embodiments, the parameters may be weighted to maintain real world properties associated with an environment. In embodiments, the environment may be a capture environment.

In embodiments, the raster image data may comprise discrete raster image data points such as one or more sets of associated data points. In embodiments, the one or more sets of associated data points may be associated with the object or may be manipulated as a single raster object.

In embodiments, the raster image data may further be transformed. In embodiments, the transformation may include transforming raster image data into at least one format suitable for use in 3D design.

In embodiments, associating may include presenting the raster image data and the spatial location data to a user for confirmation of the association. In embodiments, the association may be conditional based on the user confirmation.

In embodiments, collecting raster image data may include acquiring raster image data using image acquisition hardware. In embodiments, image acquisition hardware may include still digital cameras, optical detectors, lasers, laser measuring systems, video digital cameras, strobe lights, radar, magnetometer, or some other type of image acquisition hardware.

In embodiments, collecting raster image data may include acquiring raster image data using image acquisition software. In embodiments, image acquisition software may include image registration software, data collection software, or some other type of software for image acquisition.

In embodiments, collecting raster image data may include acquiring surface image data with a digital camera and acquiring subsurface image data with radar.

In embodiments, the raster image data may further be weighed. In embodiments, the weighting may include weighting one or more of individual raster image data points, one or more sets of raster image data points, segments of raster image data points, the object, or some other parameter. In embodiments, weighting may facilitate spatially aligning data from different collection sources. In embodiments, the raster image data weight may impact an association of at least a portion of the raster image data with spatial location data.

In embodiments, the spatial location facility may be selected from GPS, a gyro-based system, compass, a dead reckoning system, or some other type of location facility. In embodiments, the spatial location facility may be adapted to facilitate indoor location data collection.

In embodiments, the present invention provides methods and systems for taking an image of geo-referenced spatial resolution raster data, comparing the image to a computer-accessible specification, wherein the computer-accessible specification may include geographic position information and determining compliance with the specification via observation of the raster data. In embodiments, this method may further include providing a compliance report based on the determination.

In embodiments, a method for determining compliance by comparing a geo-referenced data to a specification may include taking an image of geo-referenced spatial resolution raster data, comparing the image to a computer-accessible specification, and determining compliance o with the specification via observation of the raster data. The computer-accessible specification may include geographic position information. The method may further include providing a compliance report based on the determination.

In embodiments, a method for determining compatibility of a new Facility with dimensions of an area by geo-referenced imaging may include imaging an area by disposing a location-referenced raster imaging facility in proximity to the area, calculating the position of a plurality of points in the image with reference to the location of the location-referenced raster image facility, and comparing at least a portion of the image with a design feature of a new facility to determine compatibility of the new facility with a dimension of the area. The area may include at least two other location-referenced static facilities of known dimension. In embodiments, calculating the position may include referencing the two location-referenced static facilities.

In embodiments, a method for determining compatibility specific to an application may include taking an image of an area, wherein the image includes location-referenced spatial resolution raster data, calculating locations of items in the image, and using the raster data to facilitate determining compatibility of a new facility with the area.

In embodiments, a method for determining compliance of the area with the specification may include taking an image of an area, wherein the image includes location-referenced spatial resolution raster data, calculating locations of items in the image, taking a computer-accessible specification associated with the area, wherein the computer-accessible specification includes location information, comparing the item locations in the area with the specification, and determining compliance of the area with the specification based on the comparison. In embodiments, an image of an area may be an image of a physical object. In embodiments, the items may be features of the physical object.

In embodiments, a method for managing location changes may include periodically capturing an image of a facility using raster imaging, monitoring object locations in the periodically acquired image data, determining changes to object locations over time, and comparing location changes to a specification to determine if remedial actions are required.

In embodiments, a method for navigating an environment within a 3D Model may include providing three-dimensional waypoints within a scanned model representing scanner locations and rendering the waypoints as active elements within a display that permits navigation among scanner locations within a virtual environment of the model. In embodiments, the scanned model may include raster image data.

In embodiments, a method for maintenance bidding based on virtual facility represented by a raster image data object may include providing a raster scan of a volume of a facility, supplementing the scan with at least one of object data, technical specifications, and facility information providing a virtual facility, and requesting a maintenance bid based on the virtual facility and a job description.

In embodiments, a method for full-facility scan may include providing a scanning system coupled with a location facility, the scanning system producing raster image data, passing the system throughout a facility for continuous scanning, providing a full facility scan, and storing data representing the full facility scan in a spatial database.

In embodiments, a method for underground asset management may include scanning images of underground assets including pipes and equipment prior to burying, location-referencing the scanned images with planned underground position information, providing an underground asset plan, and storing the asset plan in a municipal facility asset management database. The method may further include scanning images of the planned underground position and determining a compliance of the underground assets to the planned underground position.

In embodiments, a method for construction management may include periodically acquiring high resolution geo-referenced images of an existing structure under construction, comparing the periodically acquired images to one or more architectural or engineering plans for the structure under construction, and determining compliance of the structure to the plans.

In embodiments, a method for comparing the dimension of the raster image data may include acquiring raster image data of an environment, determining a dimension of the raster image data, and comparing the dimension of the raster image data to a dimension of a proposed facility to determine compatibility of the facility with the environment.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a raster image 3D platform;

FIG. 2 depicts additional details of the platform of FIG. 1;

FIG. 3 depicts an embodiment of managing raster image data as an object;

FIG. 3A depicts a process for the embodiment of FIG. 3;

FIG. 4 depicts an embodiment of associating raster image data with a 3D model;

FIG. 4A depicts a process for the embodiment of FIG. 4;

FIG. 5 depicts an embodiment of associating the 3D raster image data objects with a spatial location data;

FIG. 5A depicts a process for the embodiment of FIG. 5;

FIG. 6 depicts an embodiment of presenting the 3D raster image object in a 3D modeling program simultaneously with presenting a 3D model object; and

FIG. 6A depicts a process for the embodiment of FIG. 6.

### DETAILED DESCRIPTION

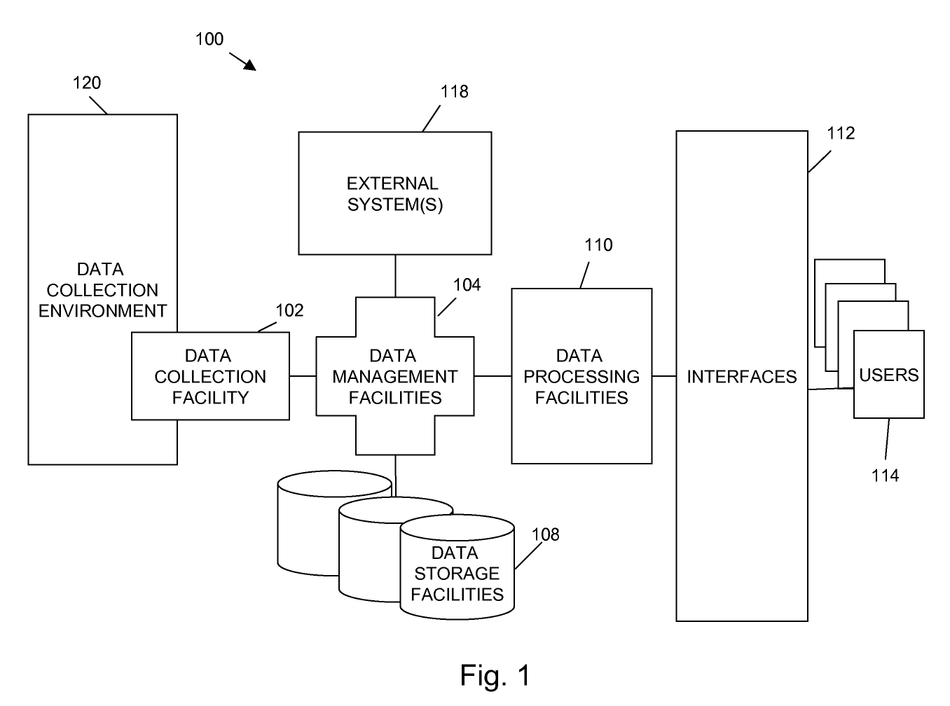

Referring to FIG. 1, a raster image 3D platform 100 may provide support for collection, management, storage, processing, analysis, and presentation of data, including 3D raster image data, in a variety of environments by a variety of users for a range of uses, many of which relate to the presentation of 3D images. The platform 100 may include a data collection facility 102 for collecting data in a range of environments 120, a data management facility 104 for managing data sets, such as raster image data including data from data collection facility 102 and other sources, a data storage facility 108 to facilitate storing large amounts of data, including raster image data, a data processing facility 110 for segmenting, analyzing and otherwise processing data for various uses, one or more interfaces 112 allowing access to the platform 100 and its components, optionally including human-readable user interfaces, as well as application programming interfaces or other interfaces 112 suitable for machine interactions. The interfaces 112 allow presentation of views and features customized for particular uses, including features for presenting and manipulating data objects for the benefit of various users 114 of the platform 100. In embodiments, the platform 100 or one or more of its components may be integrated with an external system 118, such as to provide a combined functionality or to expand capabilities and broaden usefulness of the platform 100. The platform 100 can be used in various use scenarios and with respect to various data collection environments 120 in which the platform 100 may be beneficially applied.

In embodiments, the platform 100 may include data collection facility 102. In certain embodiments, the data collection facility 102 may include a facility for collecting raster image data through various hardware and software aspects. Hardware aspects may include raster image acquisition devices 122 (including laser image scanners and other types), position detectors 124, and other data collectors. Software elements may include image registration software 128 and other software for data collection. Data collection facility 102 be performed in diverse environments 130 and may include collecting measurable data 132.

Raster image acquisition devices 122 may be used to collect data about a physical environment, object, structure, and the like. External and internal surfaces and aspects may be imaged with appropriate technology. Such technology may include image sensors such as still cameras, optical detectors, and the like; lasers and laser measuring systems; video imaging with digital cameras, and the like; flash technology such as strobe lights; pulse technology such as radar and magnetometer; and various combinations of these devices as needed to collect data from an environment 130. In an example, two data collection devices are combined to acquire surface and sub-surface data. In the example, a digital camera may record a front surface of a newly constructed wall of a building while radar is used to detect the studs and structural elements within the wall.

Position detection and location facilities 124 may be used to provide absolute or relative positioning of imaged elements. Position data may be collected through use of GPS, gyroscopic, dead reckoning, cellular, compass based, and other position detection facilities 124. By coordinating the collection of image data and position data, all image data can be associated with a position so that the resulting combination provides volume based image data that is also known as voxel (volume pixel) data. In an example, a GPS device is used to confirm the location of a building within a job site and a compass device is used to determine the direction that the front entrance faces.

Data collection facility 102 may include software such as image registration software 128 for associating combinations of data collection input such as raster image acquisition device and laser scanner data, video imaging and laser and GPS data, and any other combination that produces useful image and position data. Image registration software 128 may facilitate setup and calibration of various data collection facility 102 hardware. Image registration software 128 may also support error detection through associating one or more sources of data being collected and looking for discrepancies. In an example, compass and GPS information may be associated to detect errors.

Data collection facility 102 may also include collecting data in diverse environments. Data collection facility 102 may occur in environments and use scenarios 120 as herein described. Environments associated with data collection facility 102 may include indoor settings, outdoor settings, under water situations, below ground collection, internal or hidden situations, and the like.

Data collection facility 102 may include collecting any type of collectable or measurable data. A subject of an image of the raster image 3D platform 100 may include attributes that may be the object of data collection, such as size, orientation, color, density, distance, surface type (e.g. reflective, absorptive, hard, soft), and the like.

The raster image 3D platform 100 may include data management facility 104. Data management may facilitate management of raster image data as 3D objects and associated metadata, as well as other data, such as position data and other data used by an enterprise of a user 114. The data management facility 104 may include managing raster image data sets 134, managing raster image data as 3D objects 138, associating raster image objects with other data sets 140, transforming data 142, and the like.

Managing sets of raster image data 134 may facilitate identifying each set of raster image data as an object, or combining a plurality of sets into an object. Sets may be managed by common attributes such as the source of data collection, the subject of the raster image, the environment, the structure or organization of the data, and the like. A set may be identified with a plurality of objects and the set may be managed so that the plurality of objects may co-exist. Managing raster image data sets 134 may facilitate resolving ambiguity associated with sets of raster image data and raster image objects. Metadata may be associated with objects and the metadata may be handled as a component of the object when managing raster image data sets 134. Metadata may be useful in tracking associations of raster image data sets 134 with objects. In an example, an object is composed of a raster image element and a metadata element, wherein the metadata element is the dimension data of the object.

Raster image data may be managed as 3D objects 138. While 3D raster image objects may be interchangeable with 3D models such as 3D CAD models, the form of a raster image 3D object is distinct from a 3D model. Managing raster image data as 3D objects may also facilitate handling the data distinctly from a set of points such as a point cloud. In an example, a 3D object comprises a raster image data set element and metadata, wherein the metadata provides volumetric information associated with the collected raster image data.

Data management facility 104 may include raster image data association 140 facilities. Raster image data sets 134 configured as objects, and raster image 3D objects 138 may be associated with other data sets, models, and the like. Information such as spatial location data, GPS location data, gyro data, size, direction, environment, and the like may be associated with raster image data sets 134 and 3D objects 138. In an example, raster image data collected from a laser scanner and position data collected from a GPS are associated by data association facilities 140 to generate a raster image 3D object.

Data management facility 104 may include raster image data transformation 142. Raster image data sets 134 and raster image 3D objects 138 may be transformed into other formats for use with other aspects of the platform 100, external systems, and other processes. Raster image objects may be transformed to be used with IT systems, design systems, maintenance systems, and the like. In an example, a preventive maintenance system may receive raster image data from the data transformation facility 142 to check for sagging of a structural support beam. More generally, a data management facility 104 may manage data associated with an enterprise, such as handling the extraction, transformation, loading, and integration of data from disparate sources within the enterprise, including among the components of the platform 100 or between the platform 100 and external systems 118, such as third party systems or other systems of the enterprise. Thus, the data management facility 118 may handle not only raster image data objects, but other kinds of data, using a wide range of known data integration capabilities, including web services, couplings, bindings, connectors, message brokers, bridges, adaptors, extraction engines, loading engines, transformation engines, cleansing facilities, clustering facilities, filtering facilities, and the like.

The raster image 3D platform 100 may include data storage facilities 108. Raster image data may require large capacity storage 144 to support large amounts of raster image data, raster image data objects, raster image 3D objects, and associated metadata. Metadata such as spatial data may be stored in association with raster image data in data storage facilities 108. Data storage facilities 108 may include short term storage that may provide support for processing, display, and data collection, and long term storage that may facilitate logging, audits, versioning, and the like.

Data storage facilities 108 may facilitate enabling database functions 148 associated with raster image data 134, objects, and 3D objects 138. Database functions 148 may include access features such as security, conditional access, transaction tracking, and the like. Features such as versioning, partitioning, query formation, associating, linking and the like may also be supported by database functions 148. In an example, an automated function performs a periodic backup of information in the data storage facilities 108. The database functions 148 provide secure access to the backup function, tracks the backup transactions, and marks the backup with a version that may be accessed when retrieving information in the backup.

To facilitate access to and use of the data stored in the data storage facilities 108 interfaces 150 may be associated with the data storage facilities 108. Interfaces may include web service interfaces, service oriented interfaces, and the like. In an example, the data storage facility 108 may be hosted by a plurality of servers, wherein each server is remotely located from the data storage facility 108. The servers may access the data storage facility 108 through a web service interface that provides a secure socket layer connection for the access, such as access over the internet.

The raster image 3D platform 100 may perform a wide range of processing functions, including segmenting data, pre-processing data from the data storage facility 108, processing the data, performing calculations on the data, performing analysis of the data, and presenting the data. Thus, a data processing facility 110 may include a wide range of processing functions, ranging from basic processing to higher-level analytics. Through data segmentation 152, data processing facility 110 may facilitate support of various display environments, other raster image processing technologies, inserting object data into other models, and other data processing related operations that may be associated with 3D raster images. Data processing facility 110 may also facilitate matching raster image data sets to libraries of objects, such as matching data collected and managed to form a pipe object with a CAD model in a CAD library. Raster and other data may be processed to form a hybrid object. In an example, collected raster image data, location data, and rendered CAD library model data may be processed to form an object that is composed of all three data types.

Data processing facility 110 may be adapted to support one or more use scenarios, such as integration with external systems 118, metadata association, metadata use/processing, raster image data association with an object identifier.

The raster image 3D platform 100 may include an interface 112. The interface 112 may include features and provide capabilities that are specific to a user type, use scenario, application, service, reporting requirement, industry, or other usage scenario, as well as features of users or applications, such as conditional access rights or security levels. An interface 112 may include user type features 162, features for specific users 164, display features 168, and manipulation features 170. An interface 112 may include a human readable interface, such as a graphical user interface, an application programming interface, a services interface (such as a web services interface in a services oriented architecture), or other forms of interface, including interfaces for general purpose computers or for specialized devices, as well as handsets and mobile devices.

User type features 162 may include features based on a type or attribute of a user. In an example, a user interface feature to change security settings may be provided to a user who has access to security features. Features to configure the platform 100 may be included in a user interface for a facilitator of the platform.

User specific features 164 may be based on the individual use login, or on a function of the user. Functions of users may include facilities managers, engineers, construction personnel, owners, database managers, IT professionals, service providers, and the like. In an example, an owner user interface 112 may include features to access legal document data such as surveys, plot plans, permits, and the like. In another example, service providers may use a user interface that includes a feature to view and/or update maintenance records.

The interface 112 may include display features 168 that may facilitate display of raster image objects 134, 3D objects 138, hybrids objects 158, and the like. Display features 168 may include support for voxel (volume pixel) display, triangle display, resolution based display, rendered object display, raw point display, point clout, and combinations of collected raster image data sets and 3D models.

The interface 112 may include manipulation features 170 for manipulating data objects such as collected raster image data, collected position data, combinations of image and position data, 3D objects, and for creating and managing 3D hybrid objects. Manipulation features 170 may allow a user to control data collection, versioning rules, default object formats, and the like. A user may use the manipulation features 170 to organize and create hybrid 3D objects.

The raster image 3D platform may support users 114, including human users, such as facility managers, engineers, construction planners, auditors, safety inspectors, owners, database managers, service providers, and the like, as well as other types of users, such as enterprises, applications, services, solutions, or the like. For example, an application may use the platform 100 via an application programming interface 112, such as to present a 3D raster data object in an environment for that application, such as a graphical user interface of that application.

An external system 118 may be integrated with or associated with the platform 100. The external system 118 may consist of a wide variety of other systems, equipment, components, services or applications, including those that integrate with the platform 100 as a whole or with components of the platform 100. Integration of external systems 118 may include data process integration 172, data collection interface integration 174, standard interfaces 178, and the like. In an example, data processing integration 172 may facilitate integration of the platform 100 with plant management systems, maintenance systems, IT systems, and the like, by providing processing capabilities that allow third party integration. In another example, a scheduling capability may be integrated into data collection facility 102 so that data is collected at the end of each operating shift as a record of work output from the shift. Data collection interface integration 174 may support the integration of third party data collection devices such as GPS phones, CAD scanners, data collector transport systems, and the like. Integration of third party systems 118 may also facilitate use of standard interfaces 178 such as data streaming, web services, and the like. In an example, a GPS camera phone may provide streaming image data and GPS data over a cellular connection that may be handled by the third part integration 118 facilities of the platform 100 to ensure the data received can be associated into a raster image data object.

The platform 100 may be usefully applied in a variety of use scenarios and environments 120. To support real world environments 120 a combination of core elements of the platform 100 may be used. Environments 120 may include physical plant infrastructure and facilities, major projects (e.g. design & maintenance modeling), municipal and private roadways, bridges, dams, pipelines, and the like. Use scenarios 120 such as building maintenance, building equipment inventory and utilization and the like may benefit from populating conventional 3D models with raster image objects. The platform 100 may be applied to maintenance records. The platform 100 may facilitate locating and or recording hidden features, providing proof of an imaged item, documentation of item (e.g. construction status, age, faults), and the like.

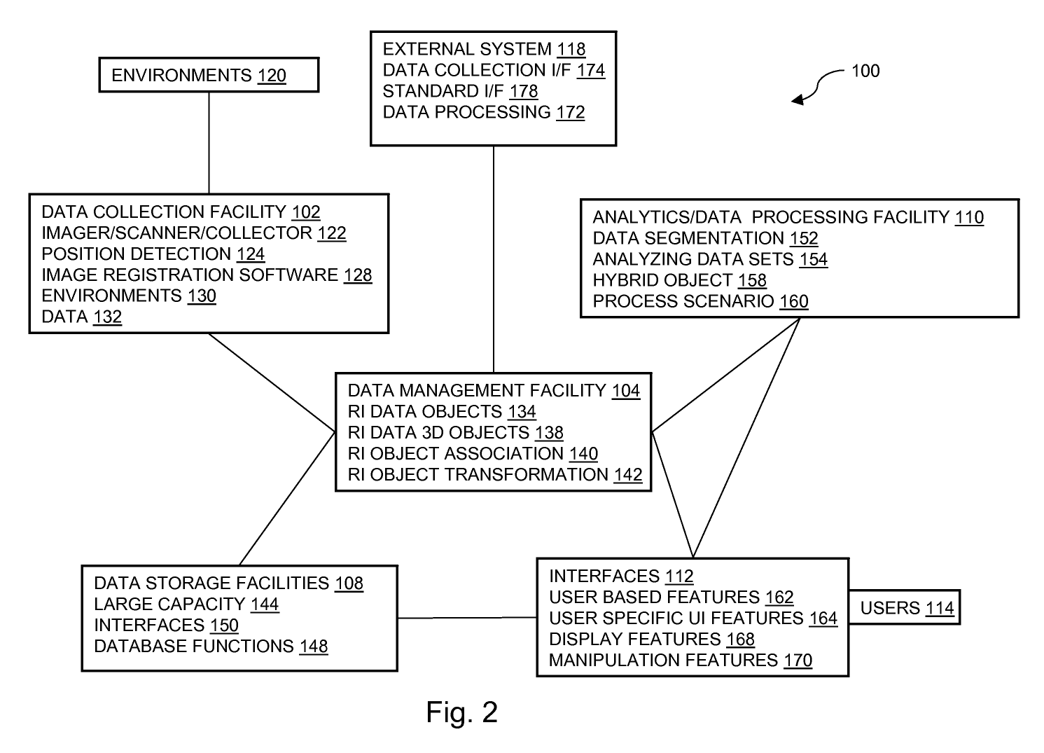

FIG. 2 provides certain additional details with respect to certain aspects of the platform 100, including additional optional capabilities with respect to the data collection facility 102, the data management facility 104, the data storage facility 108, the data processing facility 110, the interface 112, and external systems 118, as well as types of users 114, use scenarios, and data collection environments 120.

Raster image data, such as a raster image 3D object, may include attributes that facilitate combining raster image 3D objects in a virtual, CAD, modeling, simulation or similar environment in which raster image 3D objects may be combined to construct virtual assemblies of raster image 3D objects. Attributes that may facilitate combining raster image 3D objects may include connections, axis points, and other attributes related to joining or associating raster image 3D objects. Raster image 3D objects represent real-world items and therefore may be associated through connections that are found on real-world items. Connections of raster image 3D objects may include any type of connection available to a real world element such as threads, snaps, press fits, welds, sockets, locking features, joining, surface mating, and the like. Each type of connection may be related to the raster image 3D object through an axis. Such an axis may be associated with a function or operation of the connection, a motion of the raster image 3D object relative to the connection, or other feature or property of a connection. In an example, two real world elements may be connected with a pin and socket connection. One of the two raster image 3D objects may include a socket connection that includes an axis that presents a 3D vector of the proper mating direction and depth of the socket. The other of the two raster image 3D objects may include a pin connection that includes an axis that presents a 3D vector of the proper mating direction and depth of the pin. Properly connecting the socket connection of the one raster image 3D object with the pin connection of the other raster image 3D object can be accomplished by associating the 3D vector on each raster image 3D object, such as by aligning the vectors. A raster image 3D object connection may include a location. The connection location may facilitate combining raster image 3D objects by providing positional guidance during virtual assembly, constraining placement of raster image 3D objects, determining when a proper connection has been made, and the like. Connection locations may include indications of preferred connection, such as a predrilled hole in a structural member. Connections of raster image 3D objects may include connector faces that may further facilitate assembling raster image 3D objects. A connector face may be useful in defining an orientation of a raster image 3D object for connection. In an example, a raster image 3D object that has two different patterns of holes on opposite sides would need to be positioned and oriented so that the proper hole pattern is presented to a connecting raster image 3D object with the mating connection pattern. A raster image 3D object connector face may also represent a surface of the raster image 3D object that can facilitate determining proper mating of two connected raster image 3D objects in much the same way as proper mating of two real world objects could be determined by observing the relationship of the connection surfaces of the two objects.

A raster image 3D object may include connection rules or attributes. The rules or attributes may apply to one or more connections, to the raster image 3D object, or both. The attributes or connection rules may constrain or provide guidance for connectivity to other raster image 3D objects or for connectivity to non-raster objects, such as 3D CAD models, 3D definitions, spatial database entries, and the like. Examples of connection attributes include a torque setting for a threaded fastener, a minimum number of connections necessary to assemble the raster image 3D object, a maximum number of connect/disconnect actions, and any other connection related attributes, specifications, or guidelines associated with a real world connection. Connection rules or attributes for connectivity to non-raster objects may facilitate properly combing raster image 3D objects with vector 3D objects in a virtual environment such as a CAD environment. Raster image 3D object connection rules may include rotation rules. Rotation rules may be associated with one or more connection axes or rotation axes. Rotation rules may determine proper rotation actions or rotation freedom associated with one or more connections between raster image 3D objects. In an example, a threaded pipe may have a connection of type threads at one end and the axis associated with the connection may be parallel to the pipe. The rotation rules may identify a rotation motion of the pipe around the connection axis so that following the rotation rule may result in the pipe being threaded into a threaded socket of another raster image 3D object. In another example, a ball and socket connection may include a plurality of attributes or rules associated with the connection so that the freedom of rotation and tilt may be represented by the rules or attributes. Although a raster image 3D object may be composed of many individual rasters and each raster may be composed of many individual raster elements or points, the connection rules or attributes may be associated with a plurality of the raster elements in a raster and a plurality of rasters, while at the same time being associated with the raster image 3D object. In this way, the subset of the raster image 3D object most affected by the connection may be identified and therefore may be highlighted during assembly or use in a virtual environment. In an example, the points in rasters in close proximity to a connection may be highlighted when the connection is overloaded mechanically to indicate the material in the raster image 3D object near the connector is being stressed by the overloaded connection. Connections may include portions of raster image 3D object surfaces, such as may be useful for stacking raster image 3D objects. Rules associated with connection surfaces may include alignment of raster image 3D objects making surface contact, and the like.

Connections, connection rules, and axes may also facilitate controlling connectivity. Controlling connectivity may be a valuable aspect of a raster image 3D object in that it may also facilitate converting raster image 3D objects into Cutea for motion analysis without converting the raster image 3D object to vector 3D CAD.

Connections may be automatically detected during the raster capture process. Techniques for automated image connection may include image analysis, feature extraction, and the like. Alternatively, features may be automatically detected and presented to an operator for verification. Yet in another configuration, an operator may identify each connection in a raster captured image. Connections may also be automatically detected by associating, or matching a raster image 3D object to a CAD model that contains connection features. In this way, an unknown 3D raster image may be identified through an automated object detection process.

A raster image 3D object includes a set of related points that, when combined into the raster image 3D object, may represent a variety of aspects of an object that has been captured in a raster 3D form. Points within the set may each include one or more parameters resulting in parameterized points. Additionally, a group of points, such as a subset of the raster image 3D object, may be parameterized. The raster image 3D object may also be parameterized. Therefore a hierarchy of parameters that may be related to individual points may be associated with a raster image 3D object. This hierarchy may include inheritance and other rules as may be associated with a hierarchy so that parameters at a higher level, such as a subset or object level, may override point or subset level parameters. Alternatively, one or more parameters at any one level may be prioritized over other level parameters. These examples are meant to provide only a sample of the potential hierarchical relationships and/or rules included; they are not meant to be limiting, therefore other hierarchy prioritization or level association rules are herein included. Parameterized points may include capture related information such as the capture environment, a normalized point value, a range of point values, raster capture device attributes (e.g. resolution of the capture device), a plurality of values from a plurality of capture devices (e.g. a high resolution capture device value, and a low resolution capture device value), an offset value associated with lighting conditions present during capture, capture point weighting, and the like.

A parameter associated with a point, subset, or raster image 3D object may include one or more aspects associated with a vector based model as is known to be used in CAD modeling, simulation, virtual assembly, or the like. The aspect may be determined by associating a raster image 3D object with a CAD 3D model or a CAD 2D model. The CAD model may be of the same type of object, a similar object, a family of similar objects, a material class, a use or application class, or the like. The CAD model may be associated with the raster image 3D object through one or more attributes of an object such as a fire safety rating, a structural rating, a cost, a lead-time, and the like. One or more aspects associated with a vector CAD model, which may be embodied in a point parameter, may represent tensile strength, surface tension, material grain direction, and the like. Point parameters may be associated within a raster image 3D object to form important aspects of the object. In an example, an object with a variable material thickness, such as a tapered panel, may include a constant surface tension parameter for all points, yet the maximum pounds per square inch may vary with the thickness of the material. Consequently, one or more points may have different pounds per square inch parameter values within the raster image 3D object. In this way, the parameters may be associated with the object that was captured to generate the raster image 3D object.

Association of a raster image 3D object with a vector or other CAD model may be presented to the user as progressive refinement of the display image until the raster image 3D object is matched by the user to a CAD model and, for example, the raw capture and parameter data is linked to the CAD model. The degree of refinement presented to the user through a user interface may be based on a vertical market that may be representative of select users' expertise. This may benefit expert users and casual users by making it easier for them to attain an acceptable level of association.

CAD models may include nominal values for parameters (e.g. dimension) and may include a tolerance to the value to compensate for variations present in real world objects. This capacity for handling tolerance may facilitate associating a raster image 3D object to a CAD model by matching the raster image 3D object value (e.g. dimension) to a tolerance of the value.

Point, group, and raster image 3D object parameters may also facilitate manipulation of the raster image 3D object. Also, combining point or group parameters may be weighted so that the raster image 3D object maintains many of the object's real-world properties, such as flexibility, fade resistance, and the like. Applying point parameters, weighted point parameters, group parameters, weighted group parameters, raster image 3D object parameters, and/or weighted raster image 3D object parameters during a manipulation activity, such as may be performed in a CAD modeling, simulation, analysis, or virtual assembly environment, may further facilitate manipulation. In an example, a color parameter of a group of points may be changed to red, thereby flagging the group as being involved in an action or other condition. A group of points associated with a mandatory connector may be flagged if the connector is not used. A group of points that are not associated with a connector may be flagged if another raster image 3D object is attempting to connect to the group of points. In yet another example, one or more points may be flagged if, during a comparison of a raster image 3D object to a CAD model, the one or more points represent a critical variation found in the comparison, such as a connector in the CAD model missing from the raster image 3D object.

Raster capture may be performed by more than one capture device wherein each device may have different benefits and tradeoffs. A high resolution capture device may capture detail, but may operate slowly, or may have a short working distance. A low resolution capture device may not capture fine detail, but it may operate quickly and with a very large working distance. Combining capture from two devices, such as a high resolution device and a low resolution device, may facilitate improved utility of the resulting raster image 3D object. Points of the two or more capture devices may be spatially associated so that they can be aligned. Points captured from the two or more devices may also be combined in one raster image 3D object. The combined points may be used equally by weighting the points based on important differences between the devices. In an example, a capture device with 7 mm accuracy may capture many more points on an object than a device with 20 mm accuracy, therefore points from the 7 mm accuracy device may be impacted by disturbances during the capture (e.g. vibration) that do not affect the 20 mm accuracy points. Therefore, by properly weighting the points, the points from the two or more capture devices may be maintained in the raster image 3D object. Weighting may facilitate analysis such as aligning data from two or more capture systems. Weighted raster points or rasters may resist adjustment during an alignment action so that less weighted points or rasters may be affected by the aligning activity to a greater extent or before the more weighted raster points or rasters. In an example, a capture device that captures only four points near far corners of a wall may provide a reference plane for the captured wall. A different capture device that captures the surface of the wall with a high degree of 3D accuracy may capture a field of 3D points that lie in proximity to the reference plane. The reference plane may be combined with the field of 3D points to result in a raster image 3D object that represents the wall as a substantially planar surface with a high degree of acceptable variability in the wall surface.

Raster points outside a valid range of one capture system, when associated with another capture system, may be determined to be significant deviations, such as a protruding fastener, or may be determined to be insignificant, such as disturbances associated with the capture. Significant differences may be highlighted so that appropriate resolution of the difference can be made prior to the raster image 3D object being used. Insignificant differences may be smoothed so that they do not cause potential problems during use of the raster image 3D object. A valid range may be dependent on a variety of factors including aspects of the capture environment (e.g. temperature, wind speed (vibration related), lighting, etc.), aspects of the capture device (e.g. calibration date, settings, operator ID), and the like.

Raster image 3D objects may facilitate screen display manipulation in that they are, by their raster nature, readily adaptable for display on a computer screen. Making changes in a vector CAD model may require a user interacting with the vector model through a CAD user interface so that the changes impact the vector model and then are rendered on the screen. This may increase computational demand and require the user to have a level of familiarity with vector modeling. Manipulation of a raster image 3D object on a computer screen may be performed by a user using a set of raster image 3D object manipulation tools, which may be similar to CAD object manipulation tools. However, the manipulation may directly impact the raster image 3D object in that the raster image 3D object may be directly rendered on the screen. The manipulation of a raster image 3D object may involve changing the values or parameters of points, whereas manipulating vector 3D objects may involve changing the vector model. A relationship between a manipulation on a computer screen of a raster image 3D object and the raster image 3D object being manipulated may be intuitively obvious to the user, unlike the relationship of manipulating a vector 3D model.

Because a raster image 3D object is similar to a computer screen display, it may be possible to take computer memory containing the manipulated screen display and store it as a raster image 3D object in a raster image 3D object library, or other spatial database. Converting screen displayed objects into raster image 3D objects may facilitate acquiring raster image 3D objects from other means such as photographs, rendered CAD 3D models, and the like. Displayed objects, or portions of objects may be acquired in this way to facilitate applying parameters to a raster image 3D object.

A library or spatial database of raster image 3D objects may have many uses, such as 3D construction elements, and the like. Raster image 3D objects may be provided in a library of objects that may facilitate virtually building structures or other assemblies with real world methods such as welding, fastening, and other types of connections. Raster image 3D objects may be offered for sale to CAD suppliers for addition to their library of ‘parts’. However, raster image 3D objects are not just models of an object; they are raster captures of an object. The potentially intuitive relationship between a computer display of a raster image 3D object and the raster image 3D object may make it easier for a user of 2D CAD to use raster image 3D objects. Users of 2D CAD include a wide variety of construction, planning, surveying, regulatory, assembly, quality control, inspection personnel, and the like. These and many other professionals and lay people currently apply 2D CAD as part of workflows, and the like. Raster image 3D objects may conveniently fit into these workflows. In an example, a construction planner must plan staging areas for materials before the materials arrive on a job site. If the planner has a vector 2D model from a first vendor of the packaged material, and the material is being delivered from a second vendor, the model may not match. Changing the model may be cumbersome and require the planner to have a familiarity with vector modeling. An alternative to this is to have the second vendor provide a raster image 3D object of the packaged material before it ships. In this way the planner can integrate the actual packaged material raster image 3D object into a CAD planning environment, thereby ensuring the staging is accurately and timely planned.

Raster image 3D objects may also provide the benefit of allowing a user to manipulate real world object captured data instead of a ‘graphic’ that represents a CAD model which is an idealized model of a real world object. A CAD model, such as a vector model, does not automatically determine aspects of the modeled object. Even aspects as basic as the dimensions of an object cannot be determined by a CAD vector model; such aspects have to be assigned to the model. However, raster capture data as represented in a raster image 3D object may automatically determine a variety of aspects of the captured object. While the CAD vector model must be assigned dimensions, a raster capture of a real object may automatically generate dimensions during or as a consequence of the raster capture. In this way, important aspects of the object, such as the dimensions, are not at risk of being separated from the virtual representation of the object. In an example, a user of vector 3D CAD may select a model, and may also need to select dimensions for the model, thereby risking an incorrect selection of either the model or the dimensions. For a model that has dimensions pre-assigned, the pre-assigned dimensions may have been assigned incorrectly. A raster image 3D object with dimensions inherent through the raster capture process may not require selecting the object and the dimensions separately. Factors such as these further identify benefits of raster image 3D objects in that a CAD vector model with pre-assigned dimensions may be obsolete or may not accurately reflect the realities of producing the object being modeled. What may appear as subtle differences between an ideal CAD vector model and the real-world part that the model represents, may impact real world use of the object so that the resulting assembly and the virtual assembly of the CAD model may critically differ. Unfortunately, this critical difference may not be known until the real world assembly is substantially complete. This critical difference may be determined during planning or virtual assembly or CAD modeling if the raster image 3D object of the object is used instead of the not-quite-accurate yet perfect CAD vector model.

Another use for raster image 3D objects relates to production quality, customer acceptance, lot testing, and the like. Quality control personnel at manufacturers and customers are often performing various tests to ensure an object meets a quality standard or criteria. Customers may also require a first article inspection, certificate of compliance, or the like to accept an order from a manufacturer. Raster image 3D objects may facilitate such quality checking and control activities by capturing an accurate raster image of the object, such as the first object produced in a production lot, and providing the captured raster image 3D object for use in a 3D CAD or other 3D QC system. In an example, a user may receive the raster image 3D object captured from the first article or each item being produced and incorporate it into an assembly or simulated use of the object and verify that the raster image 3D object meets all the requirements of the assembly or intended use. Such an activity can be performed by the customer, the manufacturer, a third party, or may be automated so that each object produced may be raster captured and verified automatically.

Raster image 3D objects have many other uses and provide benefits in a variety of applications. Some examples of such uses and applications follow.

As noted earlier in this disclosure, 3D CAD vector models are created to represent ideal real world objects. Parameters, such as size, must be attached or otherwise associated with the model for it to embody important aspects of the real world object. Raster image 3D objects may offer an automated method for populating 3D vector or other CAD models with real data. Real data determined from the raster capture process may be provided to CAD models by associating raster image 3D objects with CAD models. In this way, aspects such as size, straightness, flatness, and other aspects that are affected by production actions can be parameterized and associated with 3D CAD models. Raster image 3D objects may also be associated with 3D CAD models during rendering and manipulation activity so that changes to the raster image 3D object through manipulation by a user may be populated into a 3D vector model without a user needing to interact with the vector model or have any familiarity with vector modeling.

During excavation and construction activity of a Greenfield project, a raster image 3D object capture, processing, and analysis platform may facilitate milestone tracking by collecting accurate raster image 3D objects of any aspects of the Greenfield site and time stamping the captured raster image 3D objects. In this way, an accurate record of activity at a Greenfield site may be captured, such as for analysis. In an example, a key milestone for a Greenfield site may be the completion of a foundation for a building. Using 3D capture devices, the size, density, features, and dimensions of the foundation can be captured, converted to raster image 3D objects and compared to an original plan. Satisfactory completion of the foundation, as determined by the raster image 3D object capture and analysis, may be tied to a milestone that may facilitate automatically initiating additional work flows such as ordering material, scheduling work, and the like.

Capturing a facility or Greenfield during construction also allows for progressive refinement of raster image 3D objects captured as different items get built during construction (girders first, etc.). Also, by using raster image 3D objects during design, the design process can follow a construction flow process (e.g. start with girders, then electrical, water, services, walls, ceilings, etc. all the way to the ribbon cutting). Change management may also benefit from applied raster image 3D objects through capturing something now, and again later, and automatically seeing differences. When combined with a timestamp and based on camera position, the raster image 3D objects acquired at various time stamps may be automatically manipulated by a CAD system to facilitate viewing from the same camera position. In a similar way, before and after imaging for insurance claims may be supported. Another potential application for raster image 3D objects is homeland security. By automating comparison between different raster image 3D objects, it may be possible to detect something that has changed (e.g. been added or is now missing).

Raster image 3D objects may facilitate maintenance requests, approval of maintenance activity completion, and record keeping. Raster image 3D objects captured before a maintenance activity may be compared to those captured after receiving a report that the maintenance activity is complete. With raster capture devices that provide accurate capture of objects that are not visible, such as a wall interior or infrastructure in a filled excavation, potential delays and real costs associated with manual inspections at interim levels of completion may be avoided or reduced. A database of maintenance requests and repair records may include raster image 3D objects as spatial records of work activity. A record that includes raster image 3D objects can be evaluated by any third party with access to the records and a CAD system. Similarly, raster image 3D objects can be used to store imperfections in a maintenance database.

Satellite imaging/navigation management may benefit from the application of raster image 3D objects. When used in combination with high resolution satellite images, raster image 3D objects can provide important information about the objects in the satellite images. Combining raster image 3D object capture technology with satellite image capture technology may result in accurate navigation maps that include three-dimensional views and object data. In an example, a line of sight from the 12^{th} floor of a building in a city may be determined from an assembly of raster image 3D objects captured of buildings in the city.

When combined with wireless broadcast technology, raster image 3D object raster capture methods can be applied to building construction so that data can be broadcast directly from the site. The data captured may be used for commercial purposes such as requesting quotations for services, repairs, improvements, and the like. In an example, a user may capture a raster image 3D object of a fixture in a building and broadcast the raster image 3D object to a number of vendors to facilitate providing a quotation or replying with a raster image 3D object of a stock equivalent of the fixture. Using a CAD type system, the raster image 3D object for the object in the building and the raster image 3D object for the object in stock can be analyzed and/or compared to ensure the stock object will be acceptable.

By capturing an accurate three-dimensional raster image of an object, raster image 3D objects may be acceptable for legal or official documentation. Photographs and models are routinely used in court room demonstrations and legal records to preserve a record of a crime site or other legally affected situation. A raster image 3D object would provide detail and the ability to adjust a perspective view not available with a photograph, while preserving the integrity of the originally captured scene. By capturing a real world object or scene 3D data, debate about the accuracy of reproduction of the object or scene normally associated with a model of the object or scene may be moot.

Raster image 3D objects may provide beneficial results in a variety of asset lifecycle management functions such as monitoring deterioration of waterfronts, assessing wear-out of moving parts in machinery, changes in structural integrity of city pipes, roads, bridges, and the like. Asset lifecycle management may facilitate early alert to problems or potential problems and facilitate accident prevention by identifying important changes in assets before catastrophic failure occurs. In an example, after an automobile accident on a bridge in which the bridge structure is involved, a raster image 3D object capture of the structure, including an x-ray capture device or another surface penetrating capture device may be viewed or analyzed for damage and impact on structural integrity. Accident prediction and analysis, such as blast analysis may be improved by raster image 3D object imaging and analysis.

While original plans for underground features such as pipes, conduit, subways, and the like may provide an accurate baseline, changes over time, including those that occur naturally (e.g. ground settling, compacting, and the like) and those that are a result of human interaction (e.g. repairs, upgrades, and the like) may render the original plans ineffective for all purposes. A raster image 3D object from a ground penetrating radar, x-ray, or similar device can be used to update plans to reflect current conditions. In this way information about underground conditions may be stored and used when new activity, such as excavation is required. Information about underground pipes may prove very important to a contractor who has the responsibility of performing an excavation activity near the pipes. In an example, a user may select a pipe (or any object) displayed in a CAD simulation or virtual environment and be able to alternate views between the original design model and the raster image 3D object captured with a raster capture device as herein described. This may allow a user to view critical differences or changes that may have occurred. The user may be provided the ability to display both the original CAD model and the raster image 3D object simultaneously. In addition to selecting alternate views, the user may be able to substitute the CAD model with the raster image 3D object so that any differences may be integrated with the other objects or models to facilitate evaluating the impact of the substitution.

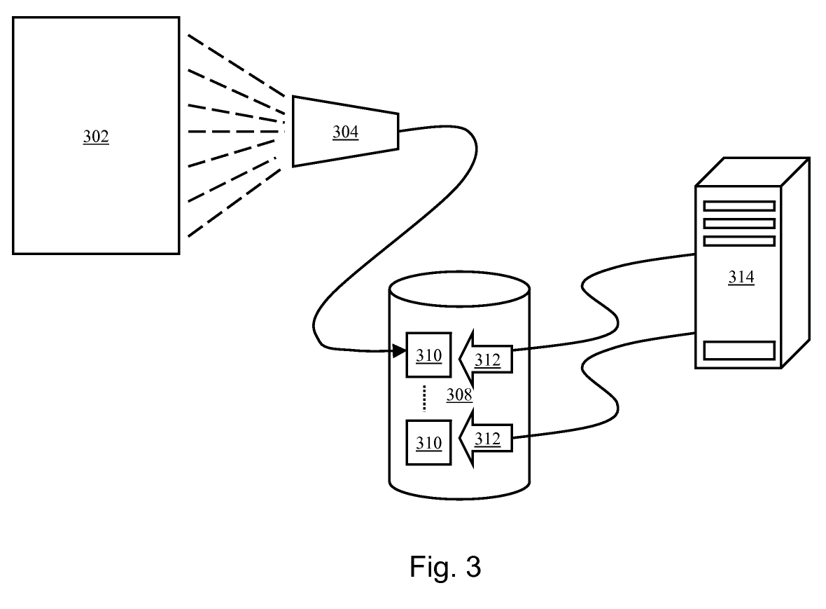

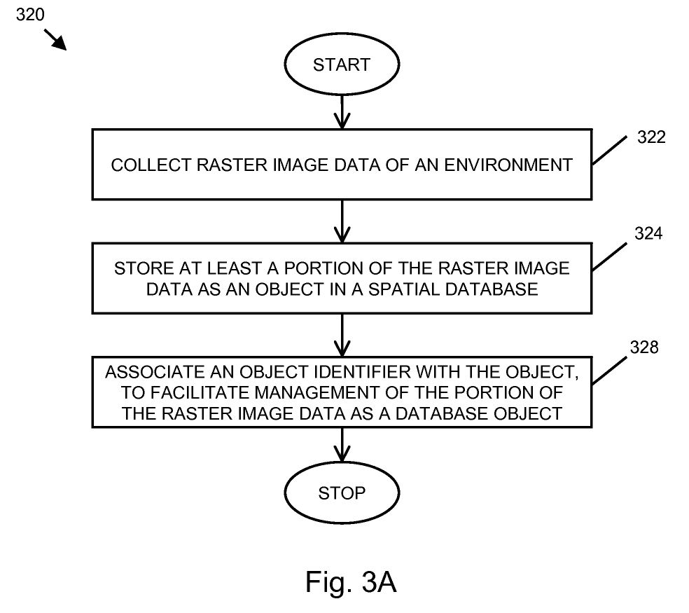

FIG. 3 depicts an embodiment for managing raster image data as an object. Raster image data of an environment 302 may be collected by a raster image collection facility 304. At least a portion of the collected raster image data may be stored as an object 310 in a spatial database 308 such as a Geographic Information System (GIS). An object identifier 312 may be associated with the stored object 310. The association of the object identifier 312 with the object 310 may facilitate management of a portion of the raster image data as a database object, such as by a computer facility 314. In embodiments, spatial database 308 may hold a plurality of objects 310 with associated object identifiers 312.

FIG. 3A depicts a process 320 for managing raster image data as an object as depicted in FIG. 3. At step 322, the raster image data of an environment 302 may be collected 304. Following this, at least a portion of the collected raster image data may be stored as an object 310 in the spatial database 308 at step 324. Further, at step 328, an object identifier 312 may be associated with the stored object 310. The association of the object identifier 312 with the object 310 may facilitate management of a portion of the raster image data as a database object.

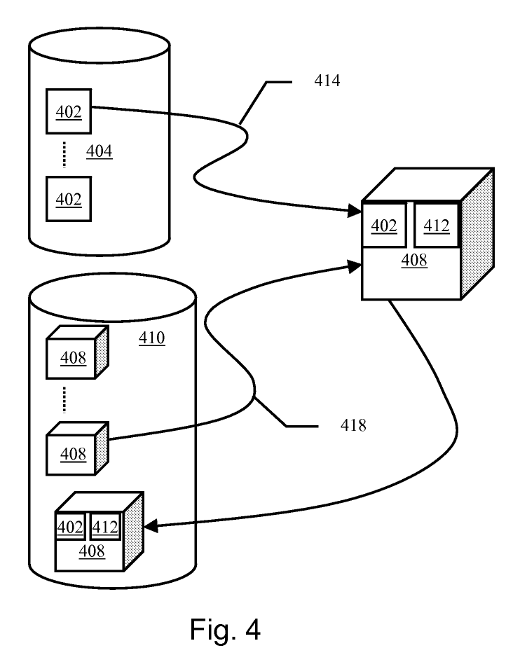

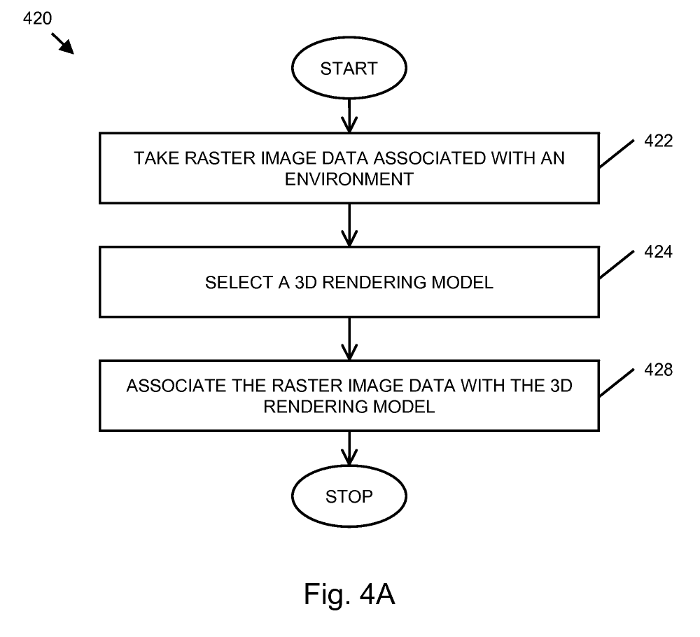

Referring to FIG. 4, raster image data may be associated with a 3D model. Raster image data associated with an environment 402 that may be stored in a storage facility 404 may be taken 414, such as being accessed by a computing facility from the storage facility 404. A 3D rendering model 408 that may be stored in a model storage facility 410 may be selected 418, such as being accessed by a computing facility from the model storage facility 410. Further, the raster image data 402 may be associated with the 3D rendering model 408 to facilitate the 3D rendering model 408 to use the raster image data 402 as an object 412 within the 3D rendering model 408. The 3D rendering model 408 with the associated raster image data 402 may be used by a computing facility such as to be stored in the model storage facility 410.

FIG. 4A depicts a process 420 for implementing at least a portion of the embodiment of FIG. 4. At step 422, the raster image data associated with an environment 402 may be taken. The environment may be the raster image data capture environment. Following this, a 3D rendering model 408 may be selected at step 424. The selection of the 3D model 408 may be based on a relationship between the raster image data and one or more components 412 of the 3D rendering model 408. Further, the raster image data 402 may be associated with the 3D rendering model 408 at step 428. This may facilitate the 3D rendering model 408 to use the raster image data 402 as an object 412 within the 3D rendering model 408.

In embodiments, association may also include presentation of the raster image data and the 3D render model to a user for confirmation of the association. Further, the association may be conditional, based on the user confirmation.

In embodiments, the object may be a hybrid object that may include object model data and associated raster image data. Further, there may be a plurality of data types such as raster image data, location data, rendered CAD library model data, and some other type of data types that may be included in the object.

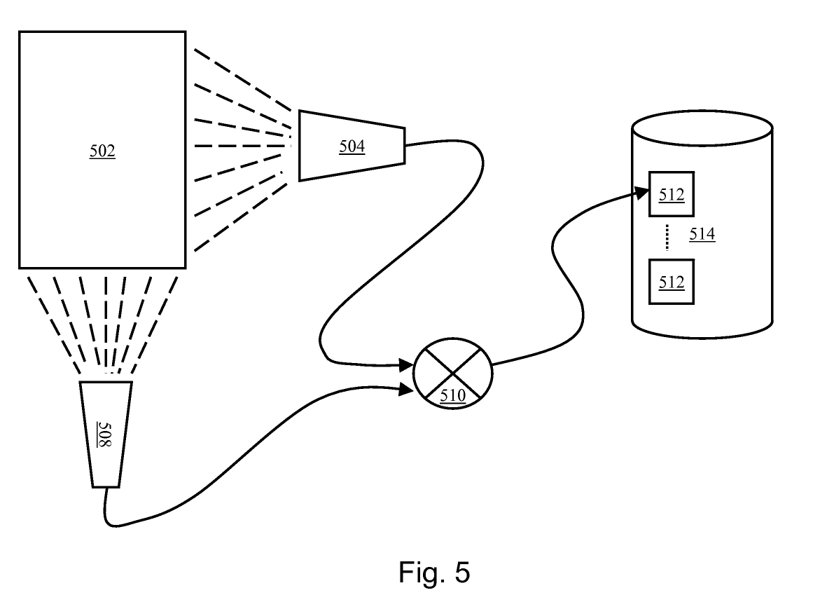

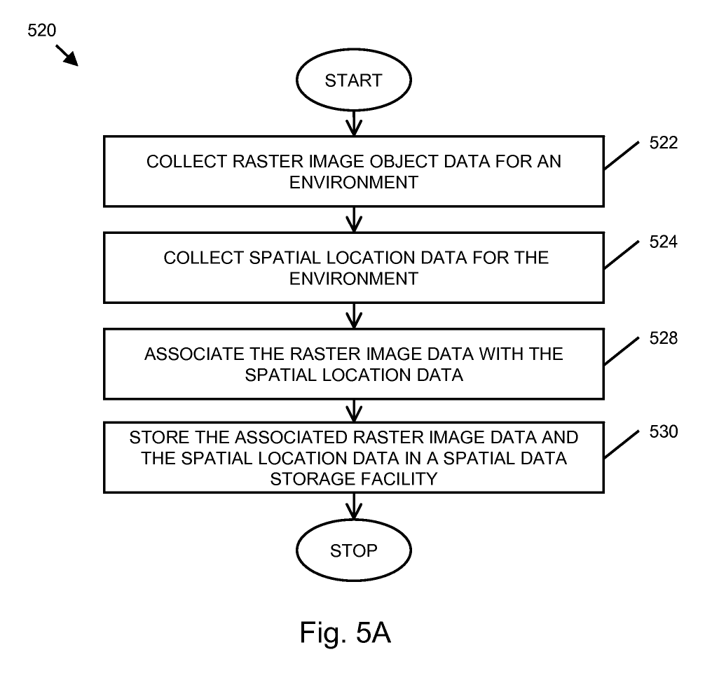

FIG. 5 depicts an embodiment for associating the 3D raster image data objects with spatial location data. Raster image object data for an environment 502 may be collected by a raster image collection facility 504. The spatial location data for the environment 502 may also be collected by a location collection facility 508. Spatial location data may be collected contemporaneously with raster image data collection. The spatial location facility may include the position detection facility 124. The collected raster image data may be associated with the collected spatial location data, such as in a computing facility 510 adapted to perform the association. The association of the raster image data with the spatial location data may provide a raster image data object 512. The object 512 of associated raster image and spatial location data may be stored in a spatial data storage facility 514. A plurality of objects 512 may be accessible in the spatial data storage facility 514.

FIG. 5A depicts a process 520 for the embodiment of FIG. 5. At step 522, the raster image object data for an environment 502 may be collected. The environment may be a raster image data capture environment. At step 524, the spatial location data for the environment 502 may be collected. The spatial location data may be collected by a spatial location facility 508 such as a position detection facility 124. Examples of position detection facility 124 may include GPS, a gyro-based system, a compass, a dead reckoning system, and some other type of position detection facility. The spatial location facility 508 may also be adapted to facilitate indoor location data collection.

The collected raster image data may be associated with the collected spatial location data at step 528. The association of the raster image data with the spatial location data may provide a raster image data object 512. The raster image data object 512 may be a three-dimensional object. Further, the spatial location data may be geo-referenced. At step 530, the associated raster image data and the spatial location data may be stored in a spatial data storage facility 514.

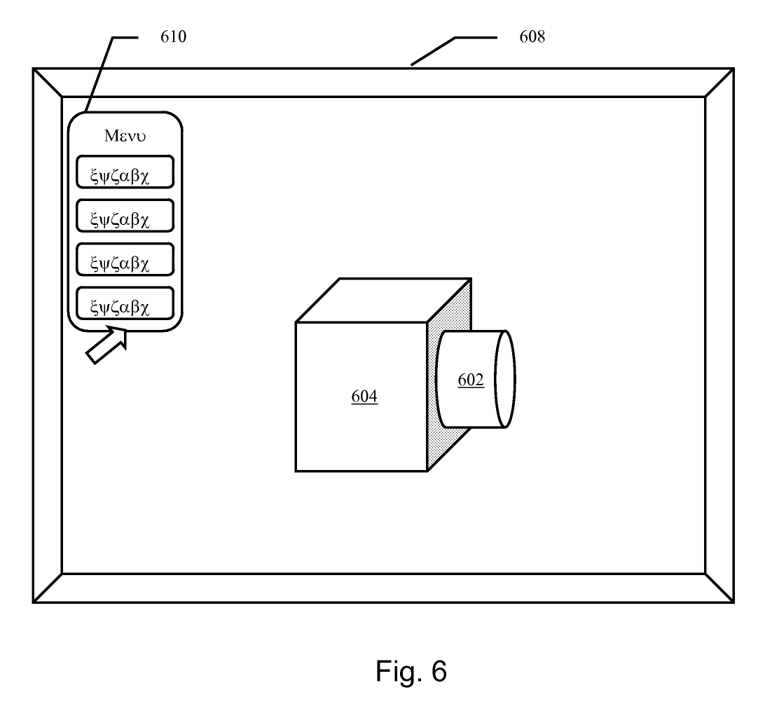

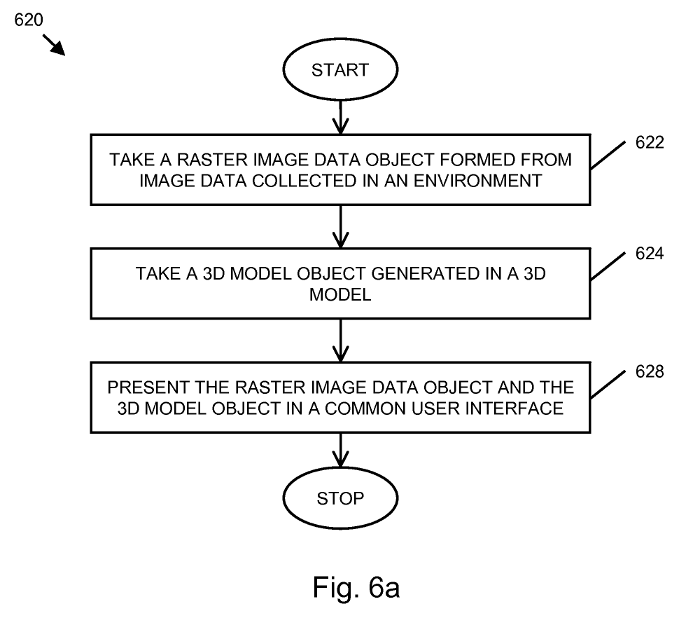

FIG. 6 depicts an embodiment of presenting the 3D raster image object in a 3D modeling program simultaneously with presenting a 3D model object. A raster image data object 602 formed from image data collected in an environment may be taken. A 3D model object 604 generated in a 3D model may be taken. Following this, the raster image data object 602 and the 3D model object 604 may be presented in a common user interface 608 that may include manipulation features 610.

Referring to FIG. 6A, a process 620 for the embodiment of FIG. 6 is presented. At step 622, the raster image data object 602 formed from image data collected in an environment may be taken. The raster image data object 602 may be a hybrid object that may include object model data and associated image data. The raster image data object 602 may also include a plurality of data types such as raster image data, location data, rendered CAD library model data, and some other types of data types.

The process may flow to step 624, where the 3D model object 604 generated in a 3D model may be taken. Following this, the raster image data object 602 and the 3D model object 604 may be presented in a user interface 608 at step 628. In embodiments, a user may manipulate the raster image data object 602 and the 3D model object 604 in the user interface. Manipulation features 610 may be provided in the user interface 608. The examples of manipulation features 610 include controlling data collection, creating hybrid 3D objects, changing object formats, connecting objects, rotating objects, and some other type of features.

The elements depicted in flow charts and block diagrams throughout the figures may imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise required by the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method comprising:
collecting raster image data of an environment;
storing at least a portion of the raster image data as an object in a spatial database; and
associating an object identifier with the object, thereby facilitating management of the portion of the raster image data as a database object.

2. The method of claim 1, wherein storing the raster image data in the spatial database enables a database function.

3. The method of claim 2, wherein the database function includes at least one of data access, versioning, partitioning, security, conditional access, query formation, transaction tracking, and logging.

4. (canceled)

5. The method of claim 1, wherein the object is a hybrid object.

6. The method of claim 5, wherein the hybrid object includes object model data and associated image data.

7-15. (canceled)

16. The method of claim 1, wherein the raster image data includes parameters.

17. (canceled)

18. The method of claim 16, wherein the parameters are weighted to maintain real world properties associated with an environment.

19-34. (canceled)

35. The method of claim 1, further including weighting raster image data.

36. (canceled)

37. The method of claim 35, wherein weighting facilitates spatially aligning data from different collection sources.

38-150. (canceled)

151. A method comprising:
collecting raster image data of an environment;
storing at least a portion of the raster image data as an object in a spatial database; and
associating the object with a three dimensional model, so that the three dimensional model can use the object within the three dimensional model.

152-158. (canceled)

159. The method of claim 151, wherein the raster image data includes attributes.

160. The method of claim 159, wherein the attributes are selected from a list consisting of data collection source, raster image subject, data collection environment, and raster image data organization.

161-173. (canceled)

174. The method of claim 151, further including transforming the raster image data.

175. The method of claim 174, wherein transforming includes transforming raster image data into at least one format suitable for use in three dimensional design.

176-184. (canceled)

185. The method of claim 151, further including weighting raster image data.

186. (canceled)

187. The method of claim 185, wherein weighting facilitates spatially aligning data from different collection sources.

188-378. (canceled)

379. A system comprising:
a collection facility for collecting raster image data of an environment;
a spatial database for storing at least a portion of the raster image data as an object; and
an object identifier that is associated with the object, thereby facilitating management of the portion of the raster image data as a database object.

380. The system of claim 379, wherein the spatial database enables a database function associated with the object.

381. The system of claim 380, wherein the database function includes at least one of data access, versioning, partitioning, security, conditional access, query formation, transaction tracking, and logging.

382. The system of claim 379, wherein the spatial database is accessible through a web service.
